(19) United States
(12) Patent Application Publication
(10) Pub. No.: US 2024/0083442 A1
(43) Pub. Date: Mar. 14, 2024

(54) DATA STORAGE METHOD AND APPARATUS, ELECTRONIC DEVICE, AND COMPUTER READABLE STORAGE MEDIUM

(71) Applicants: Beijing BOE Technology Development Co., Ltd., Beijing (CN); BOE Technology Group Co., Ltd., Beijing (CN)

(72) Inventors: Junjie ZHAO, Beijing (CN); Hongxiang SHEN, Beijing (CN)

(21) Appl. No.: 18/274,493

(22) PCT Filed: Oct. 21, 2021
(86) PCT No.: PCT/CN2021/125415

§ 371 Date: Jul. 27, 2023

(51) Int. Cl. B60W 40/09; B60W 30/182; B60W 50/08; B60W 60/00; H04L 9/00

(52) U.S. Cl. CPC B60W 40/09; B60W 30/182; B60W 50/082; B60W 60/005; H04L 9/50; B60W 2540/043; B60W 2556/10; H04L 2209/84

(57) ABSTRACT

A data storage method, an apparatus, an electronic device, and a computer-readable storage medium. The method includes: detecting a mode switching behavior performed by an operator of a vehicle, the mode switching behavior being used to trigger switching a driving mode of the vehicle between a manual driving mode and an automatic driving mode; acquiring first data corresponding to the mode switching behavior, the first data including a vehicle identification of the vehicle, switching trigger information corresponding to the mode switching behavior and time information corresponding to the mode switching behavior; storing the first data to a blockchain network.

### TECHNICAL FIELD

The present disclosure relates to the field of automatic driving technology, and more particularly, to a data storage method, a data storage apparatus, an electronic device, and a computer-readable storage medium.

### BACKGROUND

With the increasingly mature automatic driving function of vehicles, more and more vehicles with automatic driving function are driving on the roads. Usually, such vehicles can also be controlled by drivers and other operators to implement manual driving.

Relevant data generated by the vehicles during driving can be used to determine changes in driving modes of the vehicles. For example, the vehicles may experience traffic accidents while driving. After an accident occurs, the relevant data stored locally on the vehicle or in storage space in the cloud provided by the vehicle company can be obtained to determine whether the vehicle was in automatic or manual driving mode at the time of the accident, thereby facilitating attribution of liabilities for the traffic accident.

However, the status data imposes a risk of being maliciously tampered with by vehicle owners or vehicle companies. Therefore, the status data obtained through the above methods is often difficult to convince users, automatic driving providers, vehicle providers, and other relevant parties, and may even lead to disputes between relevant parties.

### SUMMARY

In view of the above, embodiments of the present disclosure provides data storage method, a data storage apparatus, an electronic device, and a computer-readable storage medium, in order to solve the deficiency in the related art.

According to a first aspect of the embodiments of the present disclosure, there is provided a data storage method, including:
detecting a mode switching behavior performed by an operator of a vehicle, the mode switching behavior being used to trigger switching a driving mode of the vehicle between a manual driving mode and an automatic driving mode;
acquiring first data corresponding to the mode switching behavior, the first data including a vehicle identification of the vehicle, switching trigger information corresponding to the mode switching behavior and time information corresponding to the mode switching behavior;
storing the first data to a blockchain network.

Optionally, prior to acquiring the first data corresponding to the mode switching behavior, the method further includes:
generating a mode switching request containing identity information of the operator;
sending the mode switching request to a decision-making server corresponding to the automatic driving mode and receiving a mode switching response returned by the decision-making server, wherein the mode switching response is used to indicate whether the operator has permission to use the automatic driving mode.

Optionally, the method further includes:
when the mode switching response indicates that the operator has permission to use the automatic driving mode, switching the driving mode of the vehicle between the manual driving mode and the automatic driving mode; and
when the mode switching response indicates that the operator does not have permission to use the automatic driving mode, refusing to switch the driving mode of the vehicle between the manual driving mode and the automatic driving mode.

Optionally, the switching trigger information includes: the mode switching request and the mode switching response.

Optionally, the mode switching behavior is a mode switching action, and the method further includes:
in response to the mode switching action, switching the driving mode of the vehicle between the manual driving mode and the automatic driving mode, wherein the switching trigger information includes video information recording the mode switching behavior.

Optionally, the method further includes:
acquiring second data corresponding to the mode switching behavior, the second data including at least one of: a vehicle identification of the vehicle, a vehicle location, vehicle status parameters, vehicle environment parameters, and behavioral parameters of the mode switching behavior;
sending the second data to the decision-making server corresponding to the automatic driving mode.

Optionally, the decision-making server includes:
a cloud server or an edge server deployed in the vehicle.

Optionally, the first data further includes identity information of the operator,
the method further includes: encrypting the identity information;
storing the first data in the blockchain network, including: storing the encrypted identity information in the blockchain network.

Optionally, the first data is stored in a blockchain network, including:
determining to-be-stored data corresponding to the first data, and initiating in the blockchain network a blockchain network transaction for the to-be-stored data;
storing the to-be-stored data in the blockchain network when consensus is reached on the blockchain network transaction.

Optionally, the method of determining the pending uplink data corresponding to the first data includes:
determining the first data as to-be-stored data; or
determining data summary of the first data as to-be-stored data, wherein the first data is saved to a preset offline storage space.

Optionally, the vehicle is connected to the blockchain network server corresponding to the provider of the vehicle through a locally running blockchain network client to access the blockchain network.

Optionally, the blockchain network is an alliance chain, wherein the members of the alliance chain include the vehicle, a first server corresponding to the provider of the vehicle, a second server corresponding to the provider of the automatic driving function, and/or a predefined supervisor server corresponding to the supervisor.

Optionally, the automatic driving mode includes:
an assisted driving mode that requires participation of the operator; and
a fully automatic driving mode without participation of the operator.

According to a second aspect of the embodiments of the present disclosure, there is provided a method for determining a driving mode, including:
determining target data stored in a blockchain network based on target vehicle identification of a target vehicle and target time information, the target data corresponding to a historical mode switching behavior performed by an operator for the target vehicle, the historical mode switching behavior being used to trigger switching of a driving mode of the target vehicle between a manual driving mode and an automatic driving mode;
acquiring target switching trigger information in the target data, and determining a historical driving mode corresponding to the target time information based on the target switching trigger information.

Optionally, determining target data stored in a blockchain network based on target vehicle identification of a target vehicle and target time information including:
determining vehicle data containing the target vehicle identification from data stored in the blockchain network, and taking vehicle data containing time information matching with the target time information as the target data.

Optionally, the target time information is a target historical time, and time information recorded in the target data indicates that the historical mode switching behavior occurred before the target historical time; and determining a historical driving mode corresponding to the target time information based on the target switching trigger information including:
determining a mode switching manner corresponding to the historical mode switching behavior based on the target switching trigger information, the mode switching manner being to switch from the manual driving mode to the automatic driving mode or from the automatic driving mode to the manual driving mode;
taking the mode after the switching corresponding to the mode switching manner as the historical driving mode corresponding to the target time information.

According to a third aspect of the embodiments of the present disclosure, there is provided a data storage apparatus including one or more processors configured to:
detect a mode switching behavior performed by an operator of a vehicle, the mode switching behavior being used to trigger switching a driving mode of the vehicle between a manual driving mode and an automatic driving mode;
acquire first data corresponding to the mode switching behavior, the first data including a vehicle identification of the vehicle, switching trigger information corresponding to the mode switching behavior and time information corresponding to the mode switching behavior;
store the first data to a blockchain network.

According to a fourth aspect of the embodiments of the present disclosure, there is provided an apparatus for determining a driving mode, including one or more processors configured to:
determine target data stored in a blockchain network based on target vehicle identification of a target vehicle and target time information, the target data corresponding to a historical mode switching behavior performed by an operator for the target vehicle, the historical mode switching behavior being used to trigger switching of a driving mode of the target vehicle between a manual driving mode and an automatic driving mode;
acquire target switching trigger information in the target data, and determine a historical driving mode corresponding to the target time information based on the target switching trigger information.

According to a fifth aspect of the embodiments of the present disclosure, there is provided an electronic device including: a processor; a memory used to store processor executable instructions; wherein the processor is configured to perform the data storage method.

According to a sixth aspect of the embodiments of the present disclosure, there is provided a computer-readable storage medium on which a computer program is stored, wherein when the program is executed by a processor, steps in the data storage method are performed.

According to the embodiments of the present disclosure, the operator of the vehicle can implement mode switching behavior to trigger switching the driving mode of the vehicle between the manual driving mode and the automatic driving mode. Correspondingly, when the vehicle detects the behavior, the vehicle can obtain the first data corresponding to the behavior, including the vehicle identification, switch trigger information, and time information corresponding to the behavior, and store the first data in the blockchain network.

On the one hand, because a blockchain network is composed of multiple blockchain network nodes, and each blockchain network node independently records the data being stored, the data stored in the blockchain network cannot be tampered with by individual blockchain network nodes, thus effectively ensuring the authenticity of the stored data. By storing the first data in the blockchain network, it is possible to utilize the characteristics of the blockchain network to achieve reliable authentication of the first data and ensure its authenticity. On the other hand, because the first data contains the vehicle identification and the switching trigger information corresponding to the mode switching behavior and time information corresponding to the mode switching behavior performed by the operator, based on the real data stored in the blockchain network, it can accurately determine the true driving mode of the vehicle at any historical time, and then accurately determine the corresponding liable party, which helps to achieve reliable attribution of driving liabilities, thus effectively avoiding disputes between relevant parties.

It is to be understood that the above general descriptions and the below detailed descriptions are merely exemplary and explanatory, and are not intended to limit the present disclosure.

### BRIEF DESCRIPTION OF THE DRAWINGS

In order to provide a clearer explanation of the technical solution in embodiments of the present disclosure, a brief introduction will be given to the accompanying drawings required in the description of the embodiments. Apparently, the accompanying drawings in the following description are only some embodiments of the present disclosure. For ordinary skilled in the art, other accompanying drawings can be obtained based on these drawings without any creative effort.

FIG. 1 is a schematic diagram illustrating a structure of a blockchain network according to embodiments of the present disclosure.

FIG. 2 is a flowchart illustrating a data storage method according to embodiments of the present disclosure.

FIG. 3 is a structural schematic diagram illustrating a vehicle according to embodiments of the present disclosure.

FIG. 4 is an interactive flowchart illustrating a data storage method according to embodiments of the present disclosure.

FIG. 5 is an interactive flowchart illustrating another data storage method illustrated according to embodiments of the present disclosure.

FIG. 6 is a flowchart illustrating a method for determining a driving mode according to embodiments of the present disclosure.

FIG. 7 is a schematic block diagram illustrating an apparatus for data storage or for determining a driving mode according to embodiments of the present disclosure.

### DETAILED DESCRIPTION OF THE EMBODIMENTS

The following will provide a clear and complete description of the technical solution in the embodiments of the present disclosure in conjunction with the accompanying drawings. Apparently, the described embodiments are only a part of the embodiments of the present disclosure, not all of them. Based on the embodiments in the present disclosure, all other embodiments obtained by ordinary skilled in the art without creative labor fall within the scope of protection in the present disclosure.

FIG. 1 is a schematic diagram illustrating a structure of a blockchain network according to an exemplary embodiment. As shown in FIG. 1, the network can include a vehicle providers 11 (such as a vehicle company), an automatic driving provider 12, a regulatory party 13, and some vehicles, such as vehicles 14, 15, and 16. Here, the vehicle provider 11 can be viewed as a first server corresponding to the vehicle provider, the automatic driving provider 12 can be viewed as a second server corresponding to the automatic driving function provider, and the regulatory party 13 can be viewed as a regulatory party server corresponding to the regulatory party. In addition, the vehicle provider 11 and the automatic driving provider 12 can be the same party, such as the vehicle company providing both vehicles and automatic driving technology to users.

Any one of the vehicles can be connected to the blockchain network as an independent blockchain node, as shown for the vehicle 14. In this scenario, any one of the vehicles is considered as a blockchain node in the blockchain network. Multiple vehicles can also be connected to the same node device and connected to the blockchain network through that node device. For example, vehicles 15 and 16 are connected to the blockchain network through the node device 17. In this scenario, the same node device connected with multiple vehicles is used as a blockchain node in the blockchain network. The node device can be provided by any one of the vehicle provider 11, the automatic driving provider 12, or the regulatory party 13, which is not limited in the embodiments of the present disclosure.

However, for the blockchain network, the number of vehicle providers, automatic driving providers, regulators, and vehicles and/or node devices included can each be one or more than one. The embodiments of the present disclosure do not impose any restrictions on the brand, style, parameters, or the like of any vehicle, as it only needs to have an automatic driving function and a manual driving function.

Any vehicle described in the embodiments of the present disclosure (such as the vehicle 14, the vehicle 15, or the vehicle 16) has both automatic and manual driving functions. When the vehicle is in the automatic driving mode, the vehicle is controlled by the automatic driving logic corresponding to the automatic driving function. When the vehicle is in the manual driving mode, it is controlled by the operator. Moreover, the automatic driving function described in the embodiments of the present disclosure includes an assisted driving function and a fully automatic driving function. Here, in an assisted driving mode corresponding to the assisted driving function, the vehicle requires participation of an operator, that is, the vehicle requires cooperate of an operator with an assisted driving logic to implement normal driving in this mode. For example, in the assisted driving mode, the vehicle can provide a user with assisted driving functions such as cruise control, lane notice, and automatic emergency braking. In a fully automatic driving mode corresponding to the fully automatic driving function, the vehicle can achieve complete driving functions without participation of the operator, that is, achieve fully automatic driving of the vehicle.

In fact, in related art, vehicle automation for automatic driving functions has multiple defined levels, such as gradually increasing automation levels of L0-L5. The concepts of manual driving mode, assisted driving mode, and fully automatic driving mode described in the embodiments of the present disclosure can correspond to the L0-L5 automatic driving levels defined in relevant art. For example, the above manual driving mode can correspond to the L0 level, the above assisted driving mode can correspond to the L1-L4 level, and the fully automatic driving mode can correspond to the L5 level. The embodiments of the present disclosure do not limit the specific correspondence between the modes and the automatic driving levels in related art.

In addition, the operator of the vehicle described in the present disclosure can be a driver of the vehicle, such as a person inside the vehicle who drives the vehicle with a steering wheel and function buttons. Alternatively, in cases where the level of automation of the vehicle is relatively high, the steering wheel may not be provided in the vehicle, and the vehicle can be driven by a person inside the vehicle (such as a passenger) through voice or action. In this case, the person inside the vehicle can be considered as the vehicle's operator. Alternatively, for vehicles with control functions at a distant (such as remote control), a person outside the vehicle who operates the vehicle through remote control can also be considered as the vehicle's operator. The specific form of operator in the embodiments of the present disclosure is not limited.

For the above vehicles, an operator can trigger a vehicle to switch between the automatic and the manual driving modes by performing a mode switching behavior. Specifically, the manual driving mode can be switched to the automatic driving mode (i.e. starting the automatic driving function), or the automatic driving mode can be switched to the manual driving mode (i.e. turning off the automatic driving function). A data storage method described in the present disclosure is used to store first data corresponding to the mode switching behavior to the blockchain. The following is a detailed explanation of the data storage method in this manual, combined with the attached drawings.

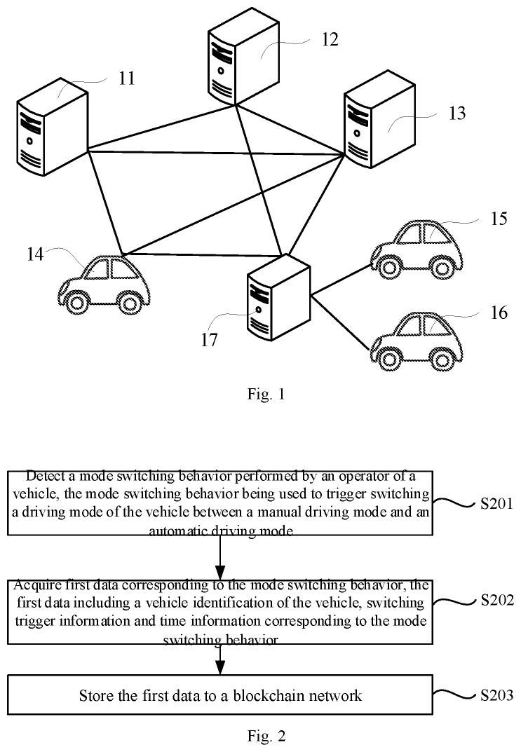

FIG. 2 is a flowchart illustrating a data storage method according to an exemplary embodiment of the present disclosure. As shown in FIG. 2, this method can include the following steps.

In step S201, a mode switching behavior performed by an operator of a vehicle is detected, the mode switching behavior is used to trigger switching a driving mode of the vehicle between a manual driving mode and an automatic driving mode.

In the embodiments of the present disclosure, the mode switching behavior performed by the operator is used to trigger switching a driving mode of the vehicle between a manual driving mode and an automatic driving mode. The mode switching behavior can include an automatic driving activation behavior and an automatic driving deactivation behavior. Here, the automatic driving activation behavior is used to trigger switching the driving mode of the vehicle from the manual driving mode to the automatic driving mode, and the automatic driving deactivation behavior is triggered by the user to switch the driving mode of the vehicle from the automatic driving mode to the manual driving mode.

The vehicle described in the embodiments of the present disclosure can be understood as the “vehicle” as a whole in the conventional sense, or a control system of the vehicle or an onboard controller. The specific meaning can be determined based on the context of embodiments of the present disclosure, and will not be elaborated in detail in the text.

In the case where the operator is inside the vehicle, the vehicle can detect the mode switching behavior performed by the operator through a sensor equipped in the vehicle. For example, the operator can move a cruise control lever to a preset position, so that a position sensor corresponding to the lever can send to the vehicle detected position information after the lever is moved. The vehicle can determine that the user has performed the mode switching behavior based on the signal. Furthermore, whether the behavior is an automatic driving activation behavior and an automatic driving deactivation behavior can be determined according to a specific value of the signal. For example, when the vehicle is in the automatic driving mode, the operator can perform the automatic driving deactivation behavior such as turning a steering wheel, pressing an accelerator pedal (or accelerator), or pressing a brake pedal (or brake). The corresponding sensor can send the detected position change information of the steering wheel, the accelerator pedal, or the brake pedal to the vehicle. The vehicle can determine based on such information that the operator has implemented an automatic driving deactivation behavior.

Alternatively, in the case where the operator is a person outside the vehicle, the vehicle can receive a mode switching command from the operator (using a control device of the vehicle) and determine an automatic driving activation or deactivation behavior performed by the operator based on the command.

The vehicle can be registered to the blockchain in advance. In one embodiment, the blockchain can be an alliance chain, and corresponding members of the alliance chain can include, in addition to the vehicle, a first server corresponding to the provider of the vehicle (such as a server of a vehicle enterprise, or the like), a second server corresponding to the automatic driving function of the vehicle provider, and/or a predefined regulatory server corresponding to the regulatory party (such as a traffic management department server, or the like). An optional structure of the alliance chain can be seen in the embodiment shown in FIG. 1, which will not be elaborated.

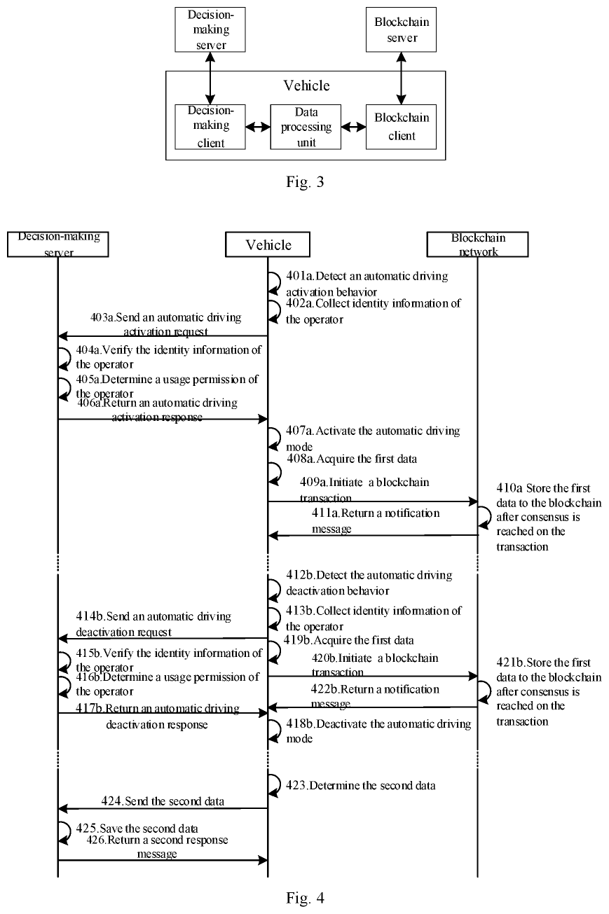

Here, the vehicle can have a blockchain client running locally. Thus, the vehicle can directly access the blockchain network through the locally running blockchain client, or connect to a blockchain server corresponding to the vehicle provider through the client to access the blockchain. As shown in FIG. 3, there is a blockchain client running in the vehicle, which is connected to the external blockchain server of the vehicle. Here, the blockchain server can serve as a blockchain node in the blockchain, so that the vehicle is connected to the blockchain node through the locally running blockchain server to access the blockchain.

As shown in FIG. 3, there is also a data processing unit running in the vehicle for obtaining the first data, which can send the obtained first data to the blockchain client for storing the first data in the blockchain. In addition, there can also be a decision-making client running in the vehicle, and the client is connected to the corresponding decision-making server of the vehicle. Here, the decision-making server can be an edge server installed in the vehicle (hardware environment) to propose the decision process, facilitate subsequent processing of mode switching requests locally on the vehicle, reduce communication time, and improve response efficiency to requests. Alternatively, the decision-making server can also be a cloud server deployed outside the vehicle (such as in a house of the server of the vehicle provider), which is convenient for more complex decision logic and richer functions, and also helps to reduce the hardware cost of the vehicle.

In step S202, first data corresponding to the mode switching behavior is acquired, the first data includes a vehicle identification of the vehicle, switching trigger information corresponding to the mode switching behavior and time information corresponding to the mode switching behavior.

After detecting the mode switching behavior, the vehicle can obtain the corresponding switching trigger information and time information, and determine such information and vehicle identification as the first data to be stored.

In one embodiment, when the mode switching behavior is detected, the vehicle can obtain identity information of the operator. For example, biometric information such as voice information, fingerprint information, and iris information can be collected from the operator. Taking voice information as an example, when the mode switching behavior performed by the operator is uttering a switching voice, the vehicle can extract voice information based on the voice uttered by the operator. Alternatively, when the mode switching behavior performed by the operator is toggling a cruise control lever, the vehicle can instruct the operator to utter a verification voice (such as playing to the operator a prompt voice of “please say the wake-up word”, displaying a text prompt of “please say the wake-up word” on the display screen, or issuing a vibration signal at a preset frequency), and collect a verification voice issued by the operator in response to this instruction. Then corresponding voice information is extracted for the voice. The voice information thus extracted can be characteristic parameters such as pitch, frequency, period, etc., and the embodiments of the present disclosure do not limit this. The fingerprint information can be feature points of a fingerprint pattern of the operator, and the iris information can be feature points or feature angles of an iris pattern, which will not be elaborated herein. For example, a vehicle can also collect information such as an account password, preset switch wake-up words, and other information of the operator as the identity information of the operator.

Furthermore, the vehicle can generate a mode switching request containing the identity information of the operator, and then send the request to the decision-making server corresponding to the automatic driving mode, and receive a mode switching response returned by the decision-making server. The mode switching response is used to indicate whether the operator has permission to use the automatic driving mode. The decision-making server is used to determine whether the operator has permission to use the automatic driving mode based on the identity information.

Correspondingly, when the automatic driving activation response indicates that the operator has permission to use the automatic driving mode, the vehicle can switch between the manual driving mode and the automatic driving mode in response to the mode switching behavior. For example, in the case where the mode switching behavior is the automatic driving activation behavior, the current manual driving mode of the vehicle can be switched to the automatic driving mode. When the mode switching behavior is the automatic driving deactivation behavior, the current automatic driving mode of the vehicle can be switched to the manual driving mode. On the contrary, in the case where the automatic driving activation response indicates that the operator does not have permission to use the automatic driving mode, the vehicle can refuse to switch to the driving mode, that is, the vehicle will maintain the current driving mode unchanged. Through this method, the vehicle decides whether to switch the driving mode based on whether the decision-making server has permission to use the automatic driving mode: only when the operator has permission to use the automatic driving mode, the vehicle switches its driving mode, avoiding users without permission to change the driving mode of the vehicle at will, which helps to ensure the legality of the driving mode switching process, reducing the difficulty in attributing driving liabilities.

The first data can include, in addition to the vehicle identification of the vehicle, corresponding switching trigger information and time information of the mode switching behavior. Here, depending on different mode switching behaviors, the switching trigger information also varies accordingly. As an exemplary embodiment, in the case where the mode switching behavior is used to trigger switching the driving mode from the manual driving mode to the automatic driving mode (i.e. the behavior is the automatic driving activation behavior), the corresponding switching trigger information may include the mode switching request sent to the decision-making server, or the mode switching response returned by the decision-making server. However, the first data can also include both the mode switching request and the mode switching response mentioned above. In this case, the time information in the first data can be a sending time of the mode switching request and/or a receiving time of the mode switching response. Alternatively, as another exemplary embodiment, in the case where the mode switching behavior is used to trigger switching the driving mode from the automatic driving mode to the manual driving mode (i.e. the behavior is the automatic driving deactivation behavior), the corresponding switching trigger information may include the mode switching request sent to the decision-making server, or the mode switching response returned by the decision-making server. Alternatively, it may include video information recording the mode switching behavior. However, the first data can also include at least two of the above three. In this case, the time information in the first data can be the sending time of the mode switching request, the receiving time of the mode switching response, and/or the collecting time of the video information (such as the capturing time of an image or a video).

In addition, depending on different manners in which the vehicle decides whether to switch the mode in response to the mode switching behavior, the switching trigger information also varies accordingly. For example, following the aforementioned embodiment, the vehicle can send the mode switching request to the decision-making server, receive the mode switching response returned by the decision-making server, and then decide whether to switch its current driving mode based on the mode switching response. In this case, the vehicle can use the mode switching request and its corresponding mode switching response as switching trigger information. In this manner, the mode switching request and the mode switching response are the decision-making basis for the vehicle, so the vehicle can save the decision-making basis for subsequent attribution of liabilities.

For example, the mode switching behavior can include mode switching actions such as turning the steering wheel, pressing the accelerator pedal, and pressing the brake pedal. Furthermore, the vehicle can switch its driving mode between the manual driving mode and the automatic driving mode in response to the mode switching action. When the above behavior is detected, the vehicle can use a previously equipped camera and other video recording device to capture a video containing the mode switching behavior. For example, when the driver presses the brake pedal with his foot, photos of the driver's foot (such as facing the brake pedal) can be taken. When the driver manually moves the cruise control lever, photos of the driver's hands (such as facing the cruise control lever) can be taken, which will not be elaborated. In this case, the vehicle does not need to interact with the decision-making server during the process of switching driving mode, but can directly switch when the above mode switching behavior is detected, greatly simplifying the vehicle's response logic to the mode switching behavior. Furthermore, the vehicle can use video information recording the mode switching behavior as switching trigger information. For example, the video information can include the video per se, the video capturing time, the video capturing object, and so on. In this manner, the video information serves as the decision-making basis for the vehicle, so the vehicle can save the decision-making basis for subsequent attribution of liabilities.

By using the mode switching request, the mode switching response, and the video information of the mode switching behavior as the switching trigger information, and storing the vehicle identification, the time information, and the switching trigger information as the first data, the mode switching behavior can be effectively traced based on the first data, facilitating the accurate determination of the vehicle's historical driving mode.

In step S203, the first data is stored to the blockchain.

After obtaining the first data, the vehicle can store the data in the blockchain. As mentioned earlier, the first data can include a mode switching request, which includes identity information of the operator. However, in the case where the first data does not include a mode switching request, in order to further determine the operator (i.e. the implementing subject of the behavior, usually the subject of the liability) who implements the mode switching behavior based on determination of the vehicle's true historical driving mode, the first data can also directly include the identity information. For the above two situations, that is, in the case where the first data includes the identity information of the operator, the identity information clearly belongs to the user privacy of the operator. To avoid potential security risks caused by privacy breaches, the vehicle can encrypt the identity information, and then store the encrypted identity information on the blockchain. Specifically, the identity information can be encrypted before being stored in the blockchain. Here, the key used for encrypting the identity information can be maintained by the vehicle, such as being preset by the operator or the vehicle owner for the vehicle and stored in the local TEE (Trusted Execution Environment) of the vehicle, thereby reducing the risk of key leakage. Alternatively, the derived key can be calculated using a key derivation algorithm based on a security root key deployed by the vehicle, and saved locally on the vehicle to further reduce the difficulty of key cracking.

In one embodiment, the vehicle can implement storage of the first data by initiating a blockchain transaction. For example, a vehicle can first determine to-be-stored data corresponding to the first data, and initiate a blockchain transaction for that data in the blockchain. Then, if consensus is reached on the blockchain transaction, the to-be-stored data can be saved in the blockchain. Through this method, after consensus of multiple blockchain nodes in the blockchain network is reached on the blockchain transaction corresponding to the first data, the first data will be stored in the blockchain, ensuring that the first data being stored has been jointly recognized by the multiple blockchain nodes.

Here, the vehicle can store the first data into the blockchain in various ways, and accordingly, the to-be-stored data can have multiple possibilities. As an exemplary embodiment, the vehicle can determine the first data as the to-be-stored data, so that the entire first data corresponding to the mode switching behavior is stored on the blockchain, ensuring the integrity of the stored data. As another exemplary embodiment, the vehicle can determine data summary of the first data as the to-be-stored data, which can be a hash of the entire first data. Correspondingly, in the case of storing the summary of the first data on the blockchain, the complete first data can be saved to a preset offline storage space, such as being saved locally on the vehicle, in the database of the vehicle's provider, or in the decision-making server. The present disclosure does not limit this in the present embodiment. Through this method, only the data summary of the first data needs to be stored in the blockchain, which greatly reduces the amount of data stored to the blockchain compared to the complete first data stored. This helps to save the on-chain storage space of the blockchain and reduce the data processing burden of each blockchain node.

The aforementioned embodiments are all for the storage process of the first data. In fact, the vehicle can also obtain second data corresponding to the mode switching behavior and send this data to the decision-making server corresponding to the automatic driving mode. Here, the second data can include at least one of: a vehicle identification of the vehicle, a vehicle location, vehicle status parameters, vehicle environmental parameters, and behavioral parameters of the mode switching behavior. Here, the vehicle position can be the longitude and latitude information of the vehicle (at the time of detecting the mode switching behavior) determined by an onboard positioning module. The vehicle positioning module can implement vehicle positioning through GPS (Global Positioning System) positioning technology, Beidou navigation positioning technology, or the like. The vehicle status parameters can include a current driving speed, an indicator light status, a multimedia device status, and so on. The vehicle environmental parameters can include a road water-logging condition, a location and/or a speed of a surrounding obstacle, a current weather condition, and so on. The behavior parameters of the mode switching behavior can include a behavior type (action or voice), an operation time, and the aforementioned switching trigger information. The embodiments of the present disclosure do not limit the specific content of the second data mentioned above.

Based on the second data, when the decision-making server obtains authorization from the operator, the server can optimize and upgrade its decision logic to further improve the corresponding decision quality. However, if the decision-making server is an edge server deployed in a vehicle, the edge server can, upon obtaining authorization from the operator, upload the second data to a preset logic training party (such as the provider of the automatic driving function), which uses the second data uploaded by multiple vehicles as training samples to train its decision logic. The trained new logic will be distributed and deployed to various edge servers to achieve the upgrading and iteration of the automatic driving function of the vehicle, and the decision-making logic of the upgraded automatic driving function will be more compliance with the current driving habits of the vehicle or the driving habits of the vehicle user.

According to the embodiments of the present disclosure, the operator of the vehicle can implement mode switching behavior to trigger switching the driving mode of the vehicle between the manual driving mode and the automatic driving mode. Correspondingly, when the vehicle detects the behavior, the vehicle can obtain the first data corresponding to the behavior, including the vehicle identification, switch trigger information, and time information corresponding to the behavior, and store the first data in the blockchain network.

On the one hand, because a blockchain network is composed of multiple blockchain network nodes, and each blockchain network node independently records the data being stored, the data stored in the blockchain network cannot be tampered with by individual blockchain network nodes, thus effectively ensuring the authenticity of the stored data. By storing the first data in the blockchain network, it is possible to utilize the characteristics of the blockchain network to achieve reliable authentication of the first data and ensure its authenticity. On the other hand, because the first data contains the vehicle identification and the switching trigger information corresponding to the mode switching behavior and time information corresponding to the mode switching behavior performed by the operator, based on the real data stored in the blockchain network, it can accurately determine the true driving mode of the vehicle at any historical time, and then accurately determine the corresponding liable party, which helps to achieve reliable attribution of driving liabilities, thus effectively avoiding disputes between relevant parties.

FIG. 4 is an interactive flowchart illustrating a data storage method according to embodiments of the present disclosure. Taking FIG. 4 as an example, the complete process of switching the driving mode to the automatic driving mode by the operator when the vehicle is in the manual driving mode, and then implementing the automatic driving deactivation behavior after a period of time to switch the driving mode to the automatic driving mode, will be explained in detail for the corresponding data storage process. As shown in FIG. 4, this process can include steps 401a-426.

In step 401a, the vehicle detects an automatic driving activation behavior.

Depending on the relative positions of the operator and the vehicle, the vehicle can use different methods to detect the automatic driving activation behavior performed by the operator.

In the case where the operator is inside the vehicle, the vehicle can detect the automatic driving activation behavior performed by the operator through its equipped sensor. Taking the operator being the driver for example, the automatic driving activation behavior performed by the driver can be an action, specifically an action of turning the cruise control lever to the “ON” position. After making this action, the position sensor corresponding to the cruise control lever can detect the position change of the control lever, which can send a corresponding position change notification message to the vehicle. Correspondingly, the vehicle can determine based on this message that the driver has made an action to toggle the cruise control lever. In addition, the message can contain the position information after the toggle (i.e. the position information corresponding to the “ON” position), so that the vehicle can determine based on this position information that the driver has taken an action to activate automatic driving. Alternatively, the automatic driving activation behavior performed by the driver can also be voice, specifically uttering a triggering voice used to activate the automatic driving function, such as saying “XXX, please activate automatic driving”. After the voice is emitted, a voice input sensor installed in the vehicle will collect the voice and be awakened by the wake-up word “XXX”. Furthermore, by identifying keywords such as “on” and “automatic driving”, it can be further determined that the operator has uttered a statement to trigger the activation of the automatic driving function, which means that the automatic driving activation behavior has been performed.

In the case where the operator is outside the vehicle, the vehicle can receive a mode switching command issued by the operator through his control device (such as a computer, a mobile phone, a smart wearable device, or the like). Correspondingly, the vehicle can determine that the operator has performed an automatic driving activation behavior based on this command. For example, the operator can trigger activation of an automatic driving button on a vehicle control page on his mobile phone. Correspondingly, upon detecting the triggering operation, the mobile phone can send an automatic driving activation command to the vehicle, so that the vehicle can determine that the operator has performed the automatic driving activation behavior based on the command.

In step 402a, the vehicle collects identity information of the operator.

In one embodiment, the identity information of the operator can be biometric information of the operator. For example, the biometric information can be voice information, specifically, it can be feature parameters such as pitch, frequency, and period of a voice. The vehicle can first obtain the voice of the operator, and then extract corresponding feature parameters based on this voice. For example, in the case where the automatic driving activation behavior is voice, the vehicle can directly extract corresponding feature parameters for the triggered voice. Alternatively, in the case where the automatic driving activation behavior is an action, the vehicle can prompt the operator to utter the voice through a voice, a text, or vibration after detecting the action, and collect the voice uttered by the operator, and then extract corresponding feature parameters for the collected voice. The specific process of extracting feature parameters from voice can be found in the relevant art of voice processing, which will not be elaborated here. For example, the biometric information can also be fingerprint information, specifically, the feature points in the fingerprint pattern. Correspondingly, the fixed speed cruise control lever of the vehicle can be equipped with a fingerprint acquisition module to collect fingerprints while the driver moves the control lever. Alternatively, a fingerprint acquisition module can be set up at positions such as the steering wheel and the center console, and the operator can be instructed to collect fingerprints on this module to extract the fingerprint information. For example, the biometric information can also be iris information, specifically, the feature points in the iris pattern. Correspondingly, the center console of the vehicle or other positions corresponding to the driver's eyes can be equipped with an iris acquisition module to collect the user's iris and extract the iris information through this module.

In another embodiment, the identity information of the operator can also be user information pre-set by the operator, such as account passwords, preset switching wake-up words, or the like. This type of user information can be used to verify the identity of the operator, which will not be elaborated.

After collecting the identity information of the operator, the vehicle can start the driving mode switching process (corresponding to steps 403a-407a) and the first data storage process (corresponding to steps 408a-411a). Description thereof will be given below.

In step 403a, the vehicle sends an automatic driving activation request to the decision-making server.

After obtaining the identity information of the operator, the vehicle can generate an automatic driving activation request containing that identity information and send the request to the decision-making server.

As mentioned earlier, the decision-making server can be a cloud server, which can serve multiple vehicles, that is, the server can receive automatic driving activation or deactivation requests sent by multiple vehicles respectively. Alternatively, the decision-making server can also be an edge server deployed locally on the vehicle, which only serves its vehicle, that is, it only receives automatic driving activation or deactivation requests sent by its vehicle. Here, the edge server usually stores the vehicle identification of the vehicle it is located in. Based on this, in the case where the decision-making server is a cloud server, the request sent by the vehicle can also include the vehicle identification to accurately inform the cloud server of the initiator of the request. In the case where the decision-making server is an edge server, the request sent by the vehicle may not include its vehicle identification.

In addition, the automatic driving activation request can also include necessary information such as the request time and the type of automatic driving activation behavior, in order to make decision judgments with the decision-making server.

In step 404a, the decision-making server verifies the identity information of the operator.

Upon receiving an automatic driving activation request from the vehicle, the decision-making server can verify the identity information of the operator included in the request. For example, in the case where the decision-making server is a cloud server, the decision-making server can locally associate and record the vehicle identification of each corresponding vehicle and the identity information of the legitimate operator (such as historical operator) of the vehicle. Correspondingly, the decision-making server can locally query whether the identity information of the operator included in the request exists based on the vehicle identification: if so, the verification is passed; otherwise, the verification will not pass. Alternatively, in the case where the decision-making server is an edge server, the decision-making server can locally record the identity information of the legitimate operator (such as a historical operator) of the vehicle in which it is located. Correspondingly, the decision-making server can locally query whether the identity information of the operator included in the request exists: if so, the verification is passed; otherwise, the verification will not pass.

If the verification is successful, it can proceed to step 405a; otherwise, it can proceed to step 406a.

In step 405a, the decision-making server determines a usage permission of the operator.

If the identity information is verified, the decision-making server can further determine the identity permission of the operator. For example, the decision-making server can record in advance a permission binding relationship table locally, which records the corresponding relationship between vehicle identification and the identity information of bound users with permission to use the automatic driving mode for that vehicle. Thus, the decision-making server can query whether the operator has permission to use the automatic driving mode for the vehicle in the permission binding relationship table corresponding to the request for automatic driving activation.

In cases where the operator does not have the usage permissions, further notification can be given to the bound users in the table, so that the operator can obtain authorization for the bound users. For example, a notification message for the automatic driving activation request can be sent to each bound user separately to inform them that the operator of the bound user is requesting activation of automatic driving mode. Furthermore, if the user acknowledges the use of the automatic driving mode of the vehicle by the operator, a confirmation message can be returned to the decision-making server. Correspondingly, the decision-making server can count the number of confirmation messages received within a preset time period and determine an authorization result for the operator's permission to use the automatic driving mode by comparing the number with the number of bound users. The specific process can be seen in Table 1 below:

TABLE 1

| Number of | Confirmation process of | |
|---|---|---|
| bound users | bound users | Authorization result |
| one | Received a confirmation | Pass |
| | message from the bound | |
| | user within a preset time | |
| | period | |
| | Received no confirmation | Pass or not pass depending |
| | message from the bound user | on the demand of the bound |
| | within a preset time period | user |
| more | Received a confirmation | pass |
| | message from one of the | |
| | bound users within a preset | |
| | time period | |
| | Received confirmation | pass |
| | messages from more than one | |
| | of the bound users within a | |
| | preset time period | |
| | Received no confirmation | Pass or not pass depending |
| | message from the bound users | on the demand of the bound |
| | within a preset time period | users |

In Table 1, if no confirmation message from the bound users is received within the preset time period, whether authorization is passed or not can be set by the bound users in advance. The embodiments of the present disclosure do not limit this.

Through the above method, if it is determined that the user has permission to use (the query result shows that he has the permission, or the bound user authorizes the permission), it can proceed to step 406a; otherwise, switching the driving mode can be refused, that is, the e current driving mode of the vehicle (i.e. the manual driving mode) is kept unchanged.

In step 406a, the decision-making server returns an automatic driving activation response to the vehicle.

Regardless of the verification result of step 404a and the determination result of step 405a, this result can be included in the automatic driving activation response and returned to the vehicle for corresponding processing. In other words, the automatic driving activation response returned by the decision-making server can be used to instruct the vehicle to switch from the current manual driving mode to the automatic driving mode; or it can be used to indicate that the vehicle refuses the switching.

In step 407a, the vehicle activates the automatic driving mode.

After receiving the automatic driving activation response, if the message indicates that the operator has permission to use the automatic driving mode of the vehicle, the vehicle can switch its driving mode from the current manual driving mode to the automatic driving mode, that is, activate the automatic driving function. The specific process of switching the driving mode can be found in relevant art, and the embodiments of the present disclosure do not limit this. Otherwise, if the message indicates that the operator does not have permission to use the automatic driving mode of the vehicle, the vehicle can refuse to switch its driving mode, that is, keep the current driving mode (i.e. the manual driving mode) of the vehicle unchanged.

In addition, regardless of whether the driving mode of the vehicle is switched or not, the vehicle can inform the operator by playing a voice, displaying a text, flashing a signal light, etc., so that the operator can know about the corresponding switching result of the mode switching behavior and try to avoid misoperation.

At this point, the process of the vehicle switching the driving mode after detecting the automatic driving activation behavior has been described. The process of storing the first data will be described below in conjunction with steps 408a-411a:

In step 408a, the vehicle acquires the first data corresponding to the mode switching behavior.

In the event of detecting the automatic driving activation behavior, the vehicle can obtain the first data to be stored. The first data includes obtaining vehicle identification, and switching trigger information and time information corresponding to the automatic driving activation behavior.

Here, the switching trigger information can take various forms. For example, after sending the automatic driving activation request containing the identity information of the operator to the decision-making server, the vehicle can use the request as a switching trigger information. For example, upon receiving the automatic driving activation response returned by the decision-making server, the vehicle can use this response as a switching trigger information.

It can be understood that in the case of using the automatic driving activation request as the switching trigger information, the vehicle needs to determine the first data after sending the automatic driving activation request, that is, step 408a needs to be performed after step 401a. In the case of using the automatic driving activation response as the switching trigger information, the vehicle needs to determine the first data after receiving the automatic driving activation response, that is, step 408a needs to be performed after step 406a. Correspondingly, the time information in the first data can be the time when the automatic driving activation request is sent, the time when the automatic driving activation response is received, and/or the time when the automatic driving activation behavior is performed, and so on. The embodiments of the present disclosure do not limit this.

For the multiple pieces of first data mentioned above, the vehicle can package them to generate a first data packet for easy data transmission and subsequent storage. In addition, as the identity information belongs to the user privacy of the operator, in order to avoid security risks caused by privacy leakage, the vehicle can encrypt the identity information and use the encrypted identity information ciphertext as a part of the first data.

In step 409a, the vehicle initiates to the blockchain network a blockchain transaction for the first data.

After obtaining the first data, the vehicle can initiate to the blockchain network a blockchain transaction for the first data. Correspondingly, each blockchain node in the blockchain network can initiate consensus on the blockchain transaction. Furthermore, each node can store the first data into the blockchain based on the consensus. Here, the generation, initiation, consensus, and execution processes of the blockchain transactions can be known from the relevant art, and the embodiments of the present disclosure do not limit this.

In step 410a, the blockchain network stores the first data to the blockchain after consensus is reached on the transaction.

In one embodiment, the vehicle can store the complete first data onto the blockchain. For example, the blockchain transaction generated by the vehicle can contain the complete first data, so that each blockchain node in the blockchain network can store the first data in the blockchain.

In another embodiment, to avoid the first data occupying a significant amount of on-chain storage space in the blockchain, the vehicle can only store the data summary of the vehicle in the blockchain and save the complete first data to a preset off-chain storage space. For example, a vehicle can calculate a hash of the first data packet and submit the hash to the blockchain in the initiated blockchain transaction. After consensus is reached on the transaction, the hash will be stored on the blockchain. In addition, the vehicle can store the first data packet locally, in the corresponding database of the vehicle's provider, and in the decision-making server. Usually, the amount of data in the data summary is much smaller than the first data, so this method can significantly reduce the occupation of on chain storage space by the first data being stored.

For the embodiments, the blockchain network can package the first data (or a summary of the first data) into a block, or store it in the world state of the blockchain in the form of a transaction receipt. The specific process will not be elaborated.

In step 411a, the blockchain network returns a notification message to the vehicle.

After the data storage is completed, the blockchain network can return a notification message to the vehicle through the corresponding blockchain node to inform a storage result of the first data. However, in the case where the blockchain transaction consensus has not been reached, the first data may not be stored in the blockchain. At this time, the blockchain network can also return a notification message to the vehicle to inform the vehicle of the reason for the failure of the storage, so that the vehicle can initiate blockchain transaction for the first data again or abandon the storage.

At this point, the description of the process for storing the first data in response to the automatic driving activation behavior has been given. As mentioned earlier, steps 403a-407a are the process of switching the driving mode, and steps 408a-411a are the process of storing the first data. The above two processes can be independently performed by the vehicle, and the specific performing sequence between the steps can be modified according to the actual situation.

The above steps 401a-411a describe the processing process after the operator performs the automatic driving activation behavior when the vehicle is in the manual driving mode. After completing step 407a, the vehicle is now in the automatic driving mode. Afterwards, the operator can perform the automatic driving deactivation behavior at any time to switch the driving mode of the vehicle back to the automatic driving mode. The following steps 412b-422b, similar to the previous steps, will be used to illustrate the process.

In step 412b, the vehicle detects the automatic driving deactivation behavior.

Depending on the relative positions of the operator and the vehicle, the vehicle can detect the automatic driving deactivation behavior performed by the operator in different ways.

In the case where the operator is inside the vehicle, the vehicle can detect the automatic driving deactivation behavior performed by the operator through a sensor equipped in the vehicle. Taking the operator being the driver as an example, the automatic driving deactivation behavior performed by the driver can be an action. Specifically, this action can be the action of turning the cruise control lever to the “OFF” position. After making this action, the position sensor corresponding to the cruise control lever can detect the position change of the control lever, which can send a corresponding position change notification message to the vehicle. Correspondingly, the vehicle can determine that the driver has made an action to toggle the cruise control lever based on this message. In addition, the message can contain the position information after the toggle (i.e. the position information corresponding to the “OFF” position mentioned above), so that the vehicle can determine based on this position information that the driver has taken the automatic driving deactivation action. Alternatively, the automatic driving deactivation behavior performed by the driver can also be at least one behavior, such as turning the steering wheel, pressing the accelerator pedal, or pressing the brake pedal. Taking the brake pedal as an example, the position sensor corresponding to the pedal can send the detected position change information to the vehicle, which can determine that the operator has performed automatic driving deactivation behavior based on this information. Alternatively, the automatic driving deactivation behavior performed by the driver can also be voice, specifically uttering the triggering voice used to deactivate the automatic driving function, such as saying “XXX, please deactivate automatic driving”. After the voice is uttered, a voice input sensor installed in the vehicle will collect the voice and be awakened by the wake-up word “XXX”. Furthermore, by recognizing keywords such as “deactivate” and “automatic driving”, it can be further determined that the operator has uttered a statement to trigger the deactivation of the automatic driving function, which means the automatic driving deactivation behavior has been performed.

In the case where the operator is outside the vehicle, the vehicle can receive a mode switching commands issued by the operator through his control device (such as a computer, a mobile phone, a smart wearable device, or the like). Correspondingly, the vehicle can determine that the operator has performed an automatic driving deactivation behavior based on this command. For example, the operator can trigger deactivation of an automatic driving button on a vehicle control page on his mobile phone. Correspondingly, upon detecting the triggering operation, the mobile phone can send an automatic driving deactivation command to the vehicle, so that the vehicle can determine that the operator has performed the automatic driving deactivation behavior based on the command.

In step 413b, the vehicle collects identity information of the operator.

The specific method for collecting the identity information of the operator is not fundamentally different from the previous step 402a. Reference can be made to the previous description and will not be elaborated here. After collecting the identity information of the operator, the vehicle can start the driving mode switching process (corresponding to steps 414b-418b) and the first data storage process (corresponding to steps 419b-422b), as described below.

In step 414b, the vehicle sends an automatic driving deactivation request to the decision-making server.

In step 415b, the decision-making server verifies the identity information of the operator.

If the verification is successful, it can proceed to step 415b; otherwise, it can refuse to switch the driving mode, that is, keep the current driving mode of the vehicle (i.e. the automatic driving mode) unchanged.

In step 416b, the decision-making server determines a permission of the operator to use the automatic driving mode.

The specific process of verifying the identity information of the operator and determining the usage permission of the operator can be found in steps 404a and 405a above, which will not be elaborated here.

If the identity information is verified, the decision-making server can further determine the identity permission of the operator. For example, the decision-making server can record in advance a permission binding relationship table locally, which records the corresponding relationship between vehicle identification and identity information of bound users with permission to use the automatic driving mode for that vehicle. Thus, the decision-making server can query whether the operator corresponding to the automatic driving deactivation request has permission to use the automatic driving mode for the vehicle in the permission binding relationship table.

In cases where the operator does not have the usage permission, a further notification can be given to the bound users in the table, so that the operator can obtain authorization for the bound users. For example, notification messages for the automatic driving deactivation request can be sent to each bound user separately to inform them that the operator of the bound user is requesting to deactivate the automatic driving mode. Furthermore, if the user acknowledges the use of the automatic driving mode of the vehicle by the operator, a confirmation message can be returned to the decision-making server. Correspondingly, the decision-making server can count the number of confirmation messages received within a preset duration and determine the authorization result for the operator's permission to use the automatic driving mode by comparing it with the number of bound users. The specific process can be seen in Table 1 above, which will not be elaborated here.

In step 417b, the decision-making server returns an automatic driving deactivation response to the vehicle.

Through the above method, if it is determined that the operator has permission (the query result shows that his has this permission, or the bound user authorizes this permission), the automatic driving deactivation response can be returned to the vehicle.

However, even if it is determined that the operator does not have the permission, the corresponding automatic driving deactivation response can be returned, for the vehicle to handle accordingly. For example, a vehicle can refuse to switch the driving mode by keeping the current driving mode (i.e. automatic driving mode) unchanged.

In step 418b, the vehicle deactivates the automatic driving mode.

After receiving the automatic driving deactivation response, if the message indicates that the operator has permission to the automatic driving mode of the vehicle, the vehicle can switch its driving mode from the current automatic driving mode to the manual driving mode, that is, turn off the automatic driving function. The specific process of switching the driving modes can be found in the relevant art, and the embodiments of the present disclosure do not limit this. Otherwise, if the message indicates that the operator does not have permission to the automatic driving mode of the vehicle, the vehicle can refuse to switch to its driving mode, that is, keep the current driving mode (i.e. automatic driving mode) of the vehicle unchanged.

In addition, regardless of whether the driving mode of the vehicle is switched or not, the operator can be informed through voice prompts, text displays, flashing signal lights, or the like, so that the operator knows the corresponding switching result of the mode switching behavior to avoid misoperation.

At this point, the vehicle has described the switching process of driving mode after detecting the automatic driving deactivation behavior. The following is description of the storage process of the first data in conjunction with steps 419b-422b.

In step 419b, the vehicle acquires the first data corresponding to the mode switching behavior.

In the event of detecting the automatic driving deactivation behavior, the vehicle can generate the first data to be stored. The first data determined can include the vehicle identification, and the switching trigger information and corresponding time information corresponding to the automatic driving deactivation behavior.

Here, the switching trigger information can take various forms. For example, after sending the automatic driving deactivation request containing the identity information of the operator to the decision-making server, the vehicle can use the request as a switch trigger information. For example, upon receiving the automatic driving deactivation response returned by the decision-making server, the vehicle can use this response as a switching trigger information.

It can be understood that in the case of using the automatic driving deactivation request as the switching trigger information, the vehicle needs to determine the first data after sending the automatic driving deactivation request, that is, step 419b needs to be executed after step 414b. In the case of using the automatic driving deactivation response as the switching trigger information, the vehicle needs to determine the first data after receiving the automatic driving deactivation response, that is, step 419b needs to be executed after step 417b.

In step 420b, the vehicle initiates to the blockchain network a blockchain transaction for the first data.

In step 421b, the blockchain network stores the first data to the blockchain after consensus is reached on the transaction.

In step 422b, the blockchain network returns a notification message to the vehicle.

The specific process of storing the first data can be found in the previous steps 409a-411a, which will not be elaborated here.

At this point, the description of the storage process of the first data in response to the automatic driving deactivation behavior has been given. As mentioned earlier, steps 414b-418b are the switching process of the driving mode, and steps 419b-422b are the storage process of the first data. The above two processes can be independently performed by the vehicle, and the specific performing sequence between the steps can be modified according to the actual situation.

The above steps are the corresponding processes for the mode switching behavior performed by the operator. In fact, after the processing of the automatic driving activation or deactivation behavior is completed, the vehicle can also obtain second data corresponding to that behavior and store it to the decision-making server. The following will be described in conjunction with steps 423 to 426.

In step 423, the vehicle determines the second data corresponding to the mode switching behavior.

After detecting any of the above mode switching behaviors, the vehicle can acquire the second data for the mode switching behavior. Specifically, the second data can include information such as the vehicle identification, time information during the process of switching the driving mode of the vehicle, the vehicle location, and the environment inside and outside the vehicle.

However, the process of acquiring the second data can be carried out by the vehicle after obtaining authorization from the operator or the vehicle owner, to ensure the operator or the vehicle owner can know about the second data has been acquired.

In step 424, the vehicle sends the second data to the decision-making server.

In step 425, the decision-making server saves the received second data.

In step 426, the decision-making server returns a second response message for the second data to the vehicle.

Then, the vehicle can send the obtained second data to the decision-making server for storage. The specific process of storage to the blockchain can be found in the previous steps 409a-411a, which will not be elaborated here. Correspondingly, after receiving the second data, the decision-making server can save it in a local storage space, or save it to a preset database or other storage space, or upload it to a preset logic training party (as provided by the provider of the automatic driving function). Furthermore, the logic training entity can use the second data uploaded by multiple vehicles as training samples to train their own decision logic, and distribute and deploy the trained new logic to various edge servers to achieve upgrading and iteration of the automatic driving function of the vehicle.

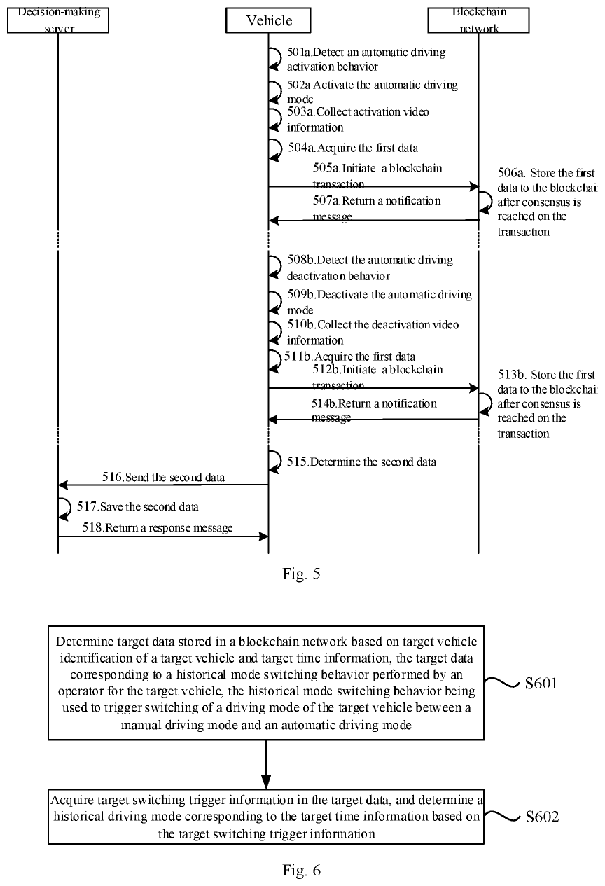

In the embodiment of FIG. 4, the vehicle interacts with the decision-making server and determines whether to switch the current driving mode based on the mode switching response returned by the decision-making server. In fact, in the case where the mode switching behavior is a mode switching action, the vehicle can also directly switch to the current driving mode after detecting the mode switching action without the need for the above interaction process. The following is description of this method in conjunction with FIG. 5.

FIG. 5 is an interactive flowchart of another data storage method shown according to the embodiments of the present disclosure. As shown in FIG. 5, the method includes the following steps 501a-518.

In step 501a, the vehicle detects an automatic driving activation action.

Depending on the relative positions of the operator and the vehicle, the vehicle can use different methods to detect the automatic driving activation action performed by the operator.

In the case where the operator is inside the vehicle, the vehicle can detect the automatic driving activation behavior performed by the operator through its equipped sensor. Taking the operator being the driver for example, the automatic driving activation behavior performed by the driver can be an action, specifically an action of turning the cruise control lever to the “ON” position. After making this action, the position sensor corresponding to the cruise control lever can detect the position change of the control lever, which can send a corresponding position change notification message to the vehicle. Correspondingly, the vehicle can determine based on this message that the driver has made an action to toggle the cruise control lever. In addition, the message can contain the position information after the toggle (i.e. the position information corresponding to the “ON” position), so that the vehicle can determine based on this position information that the driver has taken an action to activate automatic driving.

In step 502a, the vehicle activates the automatic driving mode.

When the automatic driving activation is detected, the vehicle can directly activate the automatic driving mode. This method does not require the decision-making server to make judgments based on the identity information of the operator, which can simplify the decision-making logic of the vehicle during the driving mode switching process.

In step 503a, the vehicle collects activation video information corresponding to the automatic driving activation action.

The vehicle can use equipped camera and other video recording device to continuously capture videos at a predefined location, and when the mode switching action is detected, the video clip corresponding to that action is used as the corresponding video information. Taking the user's movement of the cruise control lever as an example, the camera can continuously capture the position of the control lever and save the corresponding video. When the cruise control lever is detected to be activated, the vehicle can capture a video clip corresponding to the time interval of the activation time (such as 3 seconds before and after the activation time) from the saved video, and use this video clip as the activation video information corresponding to the automatic driving activation action. However, the activation video information can also include video time information such as the activation time and time interval.

In step 504a, the vehicle acquires the first data corresponding to the automatic driving activation action.

Upon detecting the automatic driving activation action, the vehicle can obtain the first data to be stored, for example acquiring the vehicle identification, the switching trigger information corresponding to the automatic driving activation action, and the time information. Here, the switching trigger information can be the activation video information. However, when the video information includes the video time information corresponding to the toggle action, the video time information can be used as the time information of the detected toggle action to avoid duplicate recording of time information.

In step 505a, the vehicle initiates to the blockchain network a blockchain transaction for the first data.

In step 506a, the blockchain network stores the first data to the blockchain after consensus is reached on the transaction.

In step 507a, the blockchain network returns a notification message to the vehicle.

For the specific process of storing the first data, reference can be made to the detailed description in steps 409a-411a corresponding to FIG. 4, which will not be elaborated here.

At this point, the description of the first data storage process in response to the automatic driving activation action has been given. After step 503a is completed, the vehicle is in the automatic driving mode. Afterwards, the operator can implement an automatic driving deactivation action at any time to switch the driving mode of the vehicle back to the automatic driving mode. The following steps 508b-515b, similar to the previous steps, will be used to illustrate the process.

In step 508b, the vehicle detects an automatic driving deactivation action.

In step 509a, the vehicle deactivates the automatic driving mode.

In the case of detecting the automatic driving deactivation action, the vehicle can directly deactivate the automatic driving mode, that is, turn off the automatic driving function of the vehicle. This method does not require the decision-making server to make judgments based on the identity information of the operator, which can simplify the decision-making logic of the vehicle during the driving mode switching process.

In step 510b, the vehicle collects the deactivation video information corresponding to the automatic driving deactivation action.

The vehicle can detect the automatic driving deactivation action performed by the operator through its equipped sensors. Taking the operator being the driver as an example, the automatic driving deactivation action performed by the driver can be an action. Specifically, this action can be the action of toggling the cruise control lever to the “OFF” position. For this action, the vehicle continuously records video through the camera and captures video clips related to the action as the specific process of the deactivation video information can be seen in step 502a above, which will not be elaborated here.

Alternatively, when the driving mode switching action performed by the operator include turning the steering wheel, stepping on the brake pedal, or stepping on the accelerator pedal, the vehicle can collect and capture video information corresponding to the above actions through its equipped camera, such as taking photos or recording videos. However, it is also possible to continuously record the corresponding video and, if the above actions are detected, extract the video frame image corresponding to the action from the recorded video or capture the video clip corresponding to the action as the deactivation video information. Specifically, when the driver presses the brake pedal with his foot, a video of the driver's foot (such as facing the brake pedal) can be captured to obtain the deactivation video information. When the driver manually toggles the cruise control lever, the deactivation video information can be obtained by capturing the driver's hand (such as facing the cruise control lever), which will not be elaborated.

In step 511b, the vehicle obtains the first data corresponding to the automatic driving deactivation action.

In the event of detecting the automatic driving deactivation action, the vehicle can obtain the first data to be stored. For example, obtaining vehicle identification, switching trigger information corresponding to the automatic driving deactivation action, and time information. Here, the switching trigger information can be the deactivation video information. However, in the case where the deactivation video information includes the video time information corresponding to the automatic driving deactivation action, the video time information can be used as the detected time information of the action to avoid duplicate recording of the time information.

In step 512b, the vehicle initiates to the blockchain network a blockchain transaction for the first data.

In step 513b, the blockchain network stores the first data to the blockchain after consensus is reached on the transaction.

In step 514b, the blockchain network returns a notification message to the vehicle.

For the specific process of storing the first data, reference can be made to the detailed description in steps 409a-411a corresponding to FIG. 4, which will not be elaborated here.

At this point, description of the process of the vehicle switching the driving mode after detecting the automatic driving deactivation action has been given. Similar to FIG. 4, after steps 501a-504a or 508b-511b, the vehicle can upload the corresponding second data to the decision-making server.

In step 515, the vehicle determines the second data corresponding to the mode switching action.

In step 516, the vehicle sends the second data to the decision-making server.

In step 517, the decision-making server saves the received second data.

In step 518, the decision-making server returns a response message for the second data to the vehicle.

The specific process of storing the first data can be found in the detailed description of steps 423 to 426 in FIG. 4, which will not be elaborated here.

The first data stored in the blockchain network through the aforementioned process can be used to determine a historical driving mode of the vehicle. For this purpose, the present disclosure also provides an exemplary method for determining a driving mode. FIG. 6 is a flowchart of a method for determining a driving mode shown in an exemplary embodiment of the present disclosure. As shown in FIG. 6, this method is applied to any device, such as a node device of a blockchain node in the blockchain storing the first data, a server connected to the node device, or any terminal, hereinafter referred to as a mode determination device. This method can include the following steps.

In step S601, based on a target vehicle identification of a target vehicle and target time information, target data stored in a blockchain network is determined, the target data corresponding to a historical mode switching behavior performed by the operator for the target vehicle, the historical mode switching behavior being used to trigger switching of a driving mode of the target vehicle between the manual driving mode and the automatic driving mode.

In step S602, target switching trigger information in the target data is acquired, and the historical driving mode corresponding to the target time information is determined based on the target switching trigger information.

Using the method described in the previous embodiment, the first data corresponding to the mode switching behavior performed by the operator is stored in the blockchain network. The target data in this embodiment is the first data corresponding to any of the above mode switching behaviors. As mentioned earlier, the first data includes vehicle identification, switch triggering information corresponding to the mode switching behavior, and corresponding time information. Therefore, the corresponding target data can be determined the vehicle identification and the time information.

In one embodiment, the mode determination device can receive a mode determination request initiated by the requester. For example, in the event of a traffic accident involving the target vehicle, it is necessary to determine the driving mode of the vehicle at the time of the accident, in order to identify from the vehicle manufacturer, the automatic driving provider, and the driver a party who is liable for the accident. For this purpose, the server corresponding to any of the parties or regulatory authorities (such as a traffic management department) can initiate to the mode determination device a mode determination request.

The mode determination request can include the target vehicle identification of the target vehicle and the target time information. Thus, the mode determination device can determine target data from data stored on the chain (i.e. the first data) based on the identification and the information. Specifically, the mode determination device can determine vehicle data containing the target vehicle identification from data stored in the blockchain network, and take vehicle data containing time information matching with the target time information as the target data. Furthermore, the switch trigger information included in the target data can be determined as the target switch trigger information. For example, in the case where the target vehicle identification is the vehicle's factory number and the target time information is the time of the accident mentioned above, the mode determining device can query, according to the vehicle number, all vehicle data corresponding to the target vehicle from the first data stored in the blockchain. Furthermore, in the queried vehicle data of the target vehicle, the last uploaded vehicle data before the time of the accident is searched out, and the vehicle data is used as the corresponding target data. Furthermore, the switch trigger information contained in the data is determined as the target switch trigger information.

It can be understood that the traffic accident must have occurred before the mode query, that is, compared to the current time, the time when the accident occurred is the target historical time. The time information recorded in the target data searched out should indicate that the corresponding historical mode switching behavior occurred before the target historical time. Correspondingly, the mode determining device can determine the mode switching manner corresponding to the historical mode switching behavior based on the target switching trigger information, such as determining whether to switch the manual driving mode to the automatic driving mode or from the automatic driving mode to the manual driving mode. Furthermore, the device can take the mode after the switching corresponding to the mode switching manner as the historical driving mode corresponding to the target time information, that is, determine whether the historical driving mode is the automatic driving mode or the manual driving mode.

For example, the driver of the target vehicle triggered the switching of the driving mode of the vehicle to the automatic driving mode by performing an automatic driving activation behavior at 12:00 on Sep. 15, 2021. Subsequently, by performing the automatic driving deactivation behavior at 12:15, the driving mode of the vehicle was triggered to switch to the manual driving mode, which enabled the automatic driving function for 15 minutes between 12:00 and 12:15 on Sep. 15, 2021. If the target vehicle experiences a minor traffic accident where it collides with other vehicle at 12:10 on Sep. 15, 2021, the mode determination device can use 12:10 as the time of the accident, and then determine the first data of the most recent stored before that time (i.e. the first data corresponding to the driver's automatic driving activation behavior stored at 12:00 on Sep. 15, 2021) as the target data. Therefore, based on the target switching trigger information in the data, it can be determined that the driving mode after switching is automatic driving mode, and the driving mode at 12:10 on Sep. 15, 2021 can also be determined as automatic driving mode. This can determine that the automatic driving provider (or the vehicle company) of the vehicle, rather than the driver, is liable for the accident.

Through this embodiment, for the target vehicle, the mode determination device can determine the historical driving mode of the vehicle at any historical moment. Due to the immutable nature of blockchain data, the target data stored in the blockchain can be considered authentic and trustworthy. The above historical driving mode determined based on this data can be considered as the true driving state of the target vehicle at the corresponding historical moment, which helps to accurately determine the liable party of the vehicle based on this state and effectively ensures the authenticity of the judgment.

Correspondingly to the embodiments of the data storage method, the present disclosure also provides an embodiment of a data storage apparatus.

An embodiment of the present disclosure provides a data storage apparatus, which can be a vehicle terminal or other device. In one embodiment, the apparatus includes one or more processors configured to:
detect a mode switching behavior performed by an operator of a vehicle, the mode switching behavior is used to trigger switching a driving mode of the vehicle between a manual driving mode and an automatic driving mode;
acquire first data corresponding to the mode switching behavior, the first data includes a vehicle identification of the vehicle, switching trigger information corresponding to the mode switching behavior and time information corresponding to the mode switching behavior;
store the first data to a blockchain network.

In one embodiment, the processor is further configured to:
prior to acquiring the first data corresponding to the mode switching behavior, generate a mode switching request containing identity information of the operator;
send the mode switching request to the decision-making server corresponding to the automatic driving mode and receive a mode switching response returned by the decision-making server, wherein the mode switching response is used to indicate whether the operator has permission to use the automatic driving mode.

In one embodiment, the processor is further configured to:
when the mode switching response indicates that the operator has permission to use the automatic driving mode, switch the driving mode of the vehicle between the manual driving mode and the automatic driving mode; and
when the mode switching response indicates that the operator does not have permission to use the automatic driving mode, refuse to switch the driving mode of the vehicle between the manual driving mode and the automatic driving mode.

In one embodiment, the switching trigger information includes: the mode switching request and the mode switching response.

In one embodiment, the mode switching behavior is a mode switching action, and the processor is further configured to:
in response to the mode switching action, switch the driving mode of the vehicle between the manual driving mode and the automatic driving mode, wherein the switching trigger information includes video information recording the mode switching behavior.

In one embodiment, the processor is further configured to:
acquire second data corresponding to the mode switching behavior, the second data includes at least one of: the second data includes at least one of: a vehicle identification of the vehicle, a vehicle location, vehicle status parameters, vehicle environment parameters, and behavioral parameters of the mode switching behavior;
send the second data to the decision-making server corresponding to the automatic driving mode.

In one embodiment, the decision-making server includes:
a cloud server or an edge server deployed in the vehicle.

In one embodiment, the first data further includes identity information of the operator,
the processor is further configured to encrypt the identity information;
the processor is configured to store the encrypted identity information to the blockchain network.

In one embodiment, the processor is configured to:
determine to-be-stored data corresponding to the first data, and initiate in the blockchain network a blockchain network transaction for the to-be-stored data;
store the to-be-stored data in the blockchain network when consensus is reached on the blockchain network transaction.

In one embodiment, the processor is configured to:
determine the first data as to-be-stored data; or,
determine data summary of the first data as to-be-stored data, wherein the first data is saved to a preset offline storage space.

In one embodiment, the vehicle is connected to a server of the blockchain network corresponding to a provider of the vehicle through a locally running client of the blockchain network to access the blockchain network.

In one embodiment, the blockchain network is an alliance chain, and members of the alliance chain include the vehicle, a first server corresponding to the provider of the vehicle, a second server corresponding to a provider of the automatic driving function, and/or a predefined supervisor server corresponding to a supervisor.

In one embodiment, the automatic driving mode includes:
an assisted driving mode that requires participation of the operator; and,
a fully automatic driving mode without participation of the operator.

Correspondingly to the embodiments of the data storage method, the present disclosure also provides an embodiment of an apparatus for determining a driving mode.

An embodiment of the present disclosure provides an apparatus for determining a driving mode. In one embodiment, the apparatus includes one or more processors configured to:
based on target vehicle identification of a target vehicle and target time information, determine target data stored in a blockchain network, the target data corresponding to a historical mode switching behavior performed by an operator for the target vehicle, the historical mode switching behavior being used to trigger switching of a driving mode of the target vehicle between a manual driving mode and an automatic driving mode;
acquire target switching trigger information in the target data, and determine a historical driving mode corresponding to the target time information based on the target switching trigger information.

In one embodiment, the processor is configured to:
determine vehicle data containing the target vehicle identification from data stored in the blockchain network, and take vehicle data containing time information matching with the target time information as the target data.

In one embodiment, the target time information is a target historical time, and time information recorded in the target data indicates that the historical mode switching behavior occurred before the target historical time; the processor is also configured to:
determine a mode switching manner corresponding to the historical mode switching behavior based on the target switching trigger information, the mode switching manner is to switch from the manual driving mode to the automatic driving mode or from the automatic driving mode to the manual driving mode;
take the mode after the switching corresponding to the mode switching manner as the historical driving mode corresponding to the target time information.

An embodiment of the present disclosure further provides an electronic device, including: a processor; a memory used to store processor executable instructions, wherein the processor is configured to perform the correlation determination method described in any of the above embodiments.

An embodiment of the present disclosure also proposes a computer-readable storage medium on which a computer program is stored, and when the program is executed by a processor, the steps in the correlation determination method described in any of the above embodiments are performed.

Regarding the apparatus in the above embodiment, the specific manner in which each module performs operations have been described in detail in the relevant method embodiments, which will not be elaborated here.

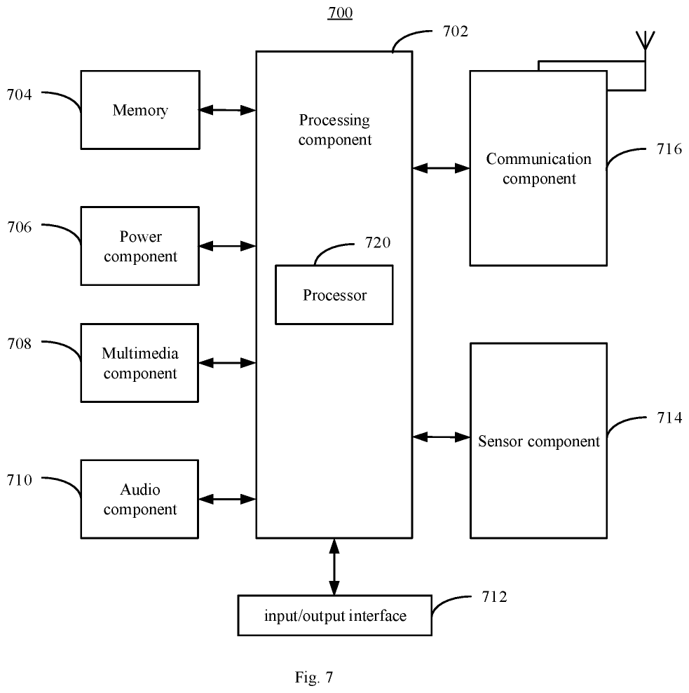

FIG. 7 is a schematic block diagram illustrating an apparatus 700 for data storage or for determining a driving mode according to embodiments of the present disclosure. Fox example, the apparatus 700 may be a mobile phone, a computer, a digital broadcast terminal, a message transceiver, a game console, a tablet device, a medical device, fitness equipment, a personal digital assistant, or the like.

Referring to FIG. 7, the apparatus 700 may include one or more following components: a processing component 702, a memory 704, a power component 706, a multimedia component 708, an audio component 710, an input/output (I/O) interface 712, a sensor component 714 and a communication component 716.

The processing component 702 typically controls overall operations of the apparatus 700, such as the operations associated with display, telephone calls, data communications, camera operations and recording operations. The processing component 702 may include one or more processors 720 to execute instructions to perform all or part of the steps in the above described methods. Moreover, the processing component 702 may include one or more modules which facilitate the interaction between the processing component 702 and other components. For example, the processing component 702 may include a multimedia module to facilitate the interaction between the multimedia component 708 and the processing component 702.

The memory 704 is configured to store various types of data to support the operation of the apparatus 700. Examples of such data include instructions for any applications or methods operated on the apparatus 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the apparatus 700. The power component 706 may include a power supply management system, one or more power sources, and any other components associated with the generation, management, and distribution of power in the apparatus 700.

The multimedia component 708 includes a screen providing an output interface between the apparatus 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and/or the rear camera may receive an external multimedia datum while the apparatus 700 is in an operation mode, such as a photographing mode or a video mode. Each of the front and rear cameras may be a fixed optical lens system or have a focus and optical zoom capability.

The audio component 710 is configured to output and/or input audio signals. For example, the audio component 710 includes a microphone (MIC) configured to receive an external audio signal when the apparatus 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the apparatus 700. For instance, the sensor component 714 may detect an open/closed status of the apparatus 700, relative positioning of components, e.g., the display and the keypad, of the apparatus 700, a change in position of the apparatus 700 or a component of the apparatus 700, a presence or absence of user's contact with the apparatus 700, an orientation or an acceleration/deceleration of the apparatus 700, and a change in temperature of the apparatus 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor or a temperature sensor.

The communication component 716 is configured to facilitate communication, wired or wirelessly, between the apparatus 700 and other apparatuses. The apparatus 700 can access a wireless network based on a communication standard, such as WiFi, 2G, 3G, 4G LTE, 6G NR, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium comprising instructions, such as comprised in the memory 704, executable by the processor 720 in the apparatus 700, for performing the above-described methods. For example, the non-transitory computer-readable storage medium may be a ROM, a RAM, a CD-ROM, a magnetic tape, a floppy disc, an optical data storage device, and the like.

Other embodiments of the disclosure will be apparent to those skilled in the art from consideration of the specification and practice of the embodiments disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

It should be noted that herein, relational terms such as first and second are only used to distinguish one entity or operation from another entity or operation, and do not necessarily require or imply any actual relationship or order between these entities or operations. The terms “comprising,” “including”, or any other variation thereof are intended to encompass non-exclusive inclusion, such that a process, method, item, or device that includes a series of elements not only includes those elements, but also other elements that are not explicitly listed, or also include elements inherent in such a process, method, item, or device. Without further limitations, the elements limited by the statement “including one . . . ” do not exclude the existence of other identical elements in the process, method, item, or equipment that includes the said elements.

The above provides a detailed introduction to the methods and apparatus provided in the embodiments of the present disclosure. Specific examples are applied herein to explain the principles and implementation methods of the present disclosure. The explanations of the above embodiments are only used to help understand the methods and core ideas of the present disclosure. In addition, for those skilled in the art, there may be changes in specific implementation methods and application scope based on the ideas of the present disclosure. Accordingly, the content of this specification should not be understood as a limitation of the present disclosure.

1. A data storage method, comprising:
detecting a mode switching behavior performed by an operator of a vehicle, the mode switching behavior being used to trigger switching a driving mode of the vehicle between a manual driving mode and an automatic driving mode;
acquiring first data corresponding to the mode switching behavior, the first data including a vehicle identification of the vehicle, switching trigger information corresponding to the mode switching behavior and time information corresponding to the mode switching behavior;
storing the first data to a blockchain network.

2. The method according to claim 1, wherein prior to acquiring the first data corresponding to the mode switching behavior, the method further comprises:
generating a mode switching request containing identity information of the operator;
sending the mode switching request to a decision-making server corresponding to the automatic driving mode and receiving a mode switching response returned by the decision-making server, wherein the mode switching response is used to indicate whether the operator has permission to use the automatic driving mode.

3. The method according to claim 2, further comprising:
when the mode switching response indicates that the operator has permission to use the automatic driving mode, switching the driving mode of the vehicle between the manual driving mode and the automatic driving mode; and
when the mode switching response indicates that the operator does not have permission to use the automatic driving mode, refusing to switch the driving mode of the vehicle between the manual driving mode and the automatic driving mode.

4. The method according to claim 2, wherein
the switching trigger information includes: the mode switching request and the mode switching response.

5. The method according to claim 1, wherein the mode switching behavior is a mode switching action, and the method further comprises:
in response to the mode switching action, switching the driving mode of the vehicle between the manual driving mode and the automatic driving mode, wherein the switching trigger information includes video information recording the mode switching behavior.

6. The method according to claim 1, further comprising:
acquiring second data corresponding to the mode switching behavior, the second data including at least one of: a vehicle identification of the vehicle, a vehicle location, vehicle status parameters, vehicle environment parameters, and behavioral parameters of the mode switching behavior;
sending the second data to the decision-making server corresponding to the automatic driving mode.

7. The method according to claim 2, wherein the decision-making server comprises:
a cloud server or an edge server deployed in the vehicle.

8. The method according to claim 1, wherein the first data further includes identity information of the operator,
the method further includes: encrypting the identity information;
storing the first data in the blockchain network, comprising: storing the encrypted identity information in the blockchain network.

9. The method according to claim 1, wherein the first data is stored in a blockchain network, comprising:
determining to-be-stored data corresponding to the first data, and initiating in the blockchain network a blockchain network transaction for the to-be-stored data;
storing the to-be-stored data in the blockchain network when consensus is reached on the blockchain network transaction.

10. The method according to claim 9, wherein the method of determining the pending uplink data corresponding to the first data comprises:
determining the first data as to-be-stored data; or
determining data summary of the first data as to-be-stored data, wherein the first data is saved to a preset offline storage space.

11. The method according to claim 1, wherein the vehicle is connected to the blockchain network server corresponding to the provider of the vehicle through a locally running blockchain network client to access the blockchain network.

12. The method according to claim 1, wherein the blockchain network is an alliance chain, wherein the members of the alliance chain comprise the vehicle, a first server corresponding to the provider of the vehicle, a second server corresponding to the provider of the automatic driving function, and/or a predefined supervisor server corresponding to the supervisor.

13. The method according to claim 1, wherein the automatic driving mode comprises:
an assisted driving mode that requires participation of the operator; and
a fully automatic driving mode without participation of the operator.

14. A method for determining a driving mode, comprising:
determining target data stored in a blockchain network based on target vehicle identification of a target vehicle and target time information, the target data corresponding to a historical mode switching behavior performed by an operator for the target vehicle, the historical mode switching behavior being used to trigger switching of a driving mode of the target vehicle between a manual driving mode and an automatic driving mode;
acquiring target switching trigger information in the target data, and determining a historical driving mode corresponding to the target time information based on the target switching trigger information.

15. The method according to claim 14, wherein determining target data stored in a blockchain network based on target vehicle identification of a target vehicle and target time information comprising:
determining vehicle data containing the target vehicle identification from data stored in the blockchain network, and taking vehicle data containing time information matching with the target time information as the target data.

16. The method according to claim 14, wherein the target time information is a target historical time, and time information recorded in the target data indicates that the historical mode switching behavior occurred before the target historical time; and determining a historical driving mode corresponding to the target time information based on the target switching trigger information comprising:
determining a mode switching manner corresponding to the historical mode switching behavior based on the target switching trigger information, the mode switching manner being to switch from the manual driving mode to the automatic driving mode or from the automatic driving mode to the manual driving mode;
taking the mode after the switching corresponding to the mode switching manner as the historical driving mode corresponding to the target time information.

17. A data storage apparatus comprising one or more processors configured to:
detect a mode switching behavior performed by an operator of a vehicle, the mode switching behavior being used to trigger switching a driving mode of the vehicle between a manual driving mode and an automatic driving mode;
acquire first data corresponding to the mode switching behavior, the first data including a vehicle identification of the vehicle, switching trigger information corresponding to the mode switching behavior and time information corresponding to the mode switching behavior;
store the first data to a blockchain network.

18. The apparatus according to claim 17, wherein the processor is further configured to:
prior to acquiring the first data corresponding to the mode switching behavior, generate a mode switching request containing identity information of the operator;
send the mode switching request to a decision-making server corresponding to the automatic driving mode and receive a mode switching response returned by the decision-making server, wherein the mode switching response is used to indicate whether the operator has permission to use the automatic driving mode.

19. The apparatus according to claim 18, wherein the processor is further configured to:
when the mode switching response indicates that the operator has permission to use the automatic driving mode, switch the driving mode of the vehicle between the manual driving mode and the automatic driving mode; and
when the mode switching response indicates that the operator does not have permission to use the automatic driving mode, refuse to switch the driving mode of the vehicle between the manual driving mode and the automatic driving mode.

20.-24. (canceled)

25. An apparatus for determining a driving mode, comprising one or more processors configured to:
determine target data stored in a blockchain network based on target vehicle identification of a target vehicle and target time information, the target data corresponding to a historical mode switching behavior performed by an operator for the target vehicle, the historical mode switching behavior being used to trigger switching of a driving mode of the target vehicle between a manual driving mode and an automatic driving mode;
acquire target switching trigger information in the target data, and determine a historical driving mode corresponding to the target time information based on the target switching trigger information.

26.-29. (canceled)
